(19) United States
(12) Patent Application Publication
(10) Pub. No.: US 2025/0319992 A1
(43) Pub. Date: Oct. 16, 2025

(54) AIRCRAFT TOW VEHICLE SYSTEM AND METHOD

(71) Applicant: Betterfrost Technologies Inc., Oakville (CA)

(72) Inventors: Sameh M. I. Saad, Stoney Creek (CA); Ahmed Sheir, Brampton (CA); Derrick Redding, Ann Arbor, MI (US)

(21) Appl. No.: 19/175,620

(22) Filed: Apr. 10, 2025

Related U.S. Application Data
(60) Provisional application No. 63/632,149, filed on Apr. 10, 2024.

(51) Int. Cl. B64F 5/20; B64C 25/26; B64D 3/00; B64D 15/12; B64D 47/00; B64F 1/227

(52) U.S. Cl. CPC B64F 5/20; B64C 25/26; B64D 3/00; B64D 15/12; B64D 47/00; B64F 1/227; B64D 2221/00

(57) ABSTRACT

There are provided methods and systems for a towbar-less aircraft tow. The towbar-less aircraft tow includes a chassis configured to receive thereon at least a portion of an aircraft main landing gear assembly. The towbar-less aircraft tow further includes a lifting mechanism coupled to the chassis, configured to raise the aircraft main landing gear assembly by a variable amount. The towbar-less aircraft tow further includes a propulsion system coupled to the chassis, configured to move the towbar-less aircraft tow in a direction along a trajectory. The towbar-less aircraft tow further includes an electrical storage system coupled to the chassis. The towbar-less aircraft tow further includes a power connector mounted to said electrical storage system, configured to connect with an aircraft de-icing system for communicating electrical power from the towbar-less aircraft tow to the aircraft de-icing system during aircraft de-icing.

### TECHNICAL FIELD

The embodiments disclosed herein relate to aircraft tow vehicles, and, in particular to an aircraft tow vehicle used in aircraft de-icing operations.

### INTRODUCTION

Ice buildup on aircrafts can pose several problems, including the creation of hazardous conditions. Therefore, it is important to ensure that the components of an aircraft are free of ice buildup.

One technique for deicing an aircraft uses chemical deicers. However, chemical de-icing requires significant amounts of time, energy, and the chemicals themselves. Furthermore, the containment and disposal of chemicals can lead to additional difficulties. As such, typically only the largest airports have chemical de-icing available, while most medium and small airports do not. In addition, airports in colder climates typically do not have chemical de-icing available, and are therefore restricted in the times that flights are able to operate during cold weather.

Accordingly, there is a need for techniques to de-ice an aircraft that are not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

A towbar-less aircraft tow is provided. The towbar-less aircraft tow includes a chassis configured to receive thereon at least a portion of an aircraft main landing gear assembly. The towbar-less aircraft tow further includes a lifting mechanism coupled to the chassis, configured to raise the aircraft main landing gear assembly by a variable amount. The towbar-less aircraft tow further includes a propulsion system coupled to the chassis, configured to move the towbar-less aircraft tow in a direction along a trajectory. The towbar-less aircraft tow further includes an electrical storage system at the chassis. The towbar-less aircraft tow further includes a power connector mounted to said electrical storage system, configured to connect with an aircraft de-icing system for communicating electrical power from the towbar-less aircraft tow to the aircraft de-icing system during aircraft de-icing.

In an embodiment, the towbar-less aircraft tow further includes at least one of: a power unit, a seat, a steering wheel, a control panel, and a cab for an operator.

In an embodiment, the electrical storage system is a battery.

In an embodiment, the electrical storage system is a portable power supply.

In an embodiment, the aircraft de-icing system includes a controller configured to operate the towbar-less aircraft tow.

In an embodiment, operating the towbar-less aircraft tow includes operating the lifting mechanism to vary a height of the aircraft main landing gear assembly.

In an embodiment, varying the height of the aircraft main landing gear assembly changes a surface angle of a wing on the aircraft.

In an embodiment, operating the towbar-less aircraft tow includes vibrating the aircraft main landing gear assembly.

In an embodiment, operating the towbar-less aircraft tow includes providing high-pressure air.

In an embodiment, the aircraft de-icing system is configured to use pulse electro-thermal de-icing (PETD) techniques.

In an embodiment, the towbar-less aircraft tow and the aircraft de-icing system are in data communication.

A method of de-icing an aircraft is provided. The method includes operably coupling an aircraft tow to a main landing gear assembly of an aircraft; connecting a power connector from the aircraft tow to an aircraft de-icing system of the aircraft to provide electric power to the aircraft de-icing system; varying, by the aircraft tow, a height of the main landing gear assembly of the aircraft to vary a surface angle of a wing on the aircraft to allow melted ice to slide off said wing.

In an embodiment, a portable power supply is located at the aircraft tow.

In an embodiment, the method further includes vibrating, by the aircraft tow, the landing gear assembly of an aircraft to remove ice from said wing.

In an embodiment, the method further includes applying high-pressure air to remove ice from said wing.

In an embodiment, the aircraft de-icing system includes an onboard controller configured to operate the aircraft tow.

In an embodiment, the aircraft de-icing system is configured to use pulse electro-thermal de-icing (PETD) techniques.

In an embodiment, the aircraft de-icing system is one of internal to the aircraft, and external to the aircraft.

In an embodiment, the aircraft tow and the aircraft de-icing system are in data communication.

In an embodiment, the data communication allows for automated de-icing of the aircraft without human intervention.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 depicts a block diagram of an example system for using a towbar-less aircraft tow, according to an embodiment of the present disclosure.

FIG. 2 depicts a side perspective of an example aircraft tow vehicle, according to an embodiment of the present disclosure.

FIGS. 3, 4 and 5 depict an example de-icing process, according to an embodiment of the present disclosure.

FIG. 6 depicts a method flow of operating the system of FIG. 1, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

As used herein, the term “about” should be read as including variation from the nominal value, for example, a +/−10% variation from the nominal value. It is to be understood that such a variation is always included in a given value provided herein, whether or not it is specifically referred to.

Due to the limitations of chemical de-icing of aircrafts, an emerging alternative is thermal electrical de-icing using the conductive layers within the aircraft wing for ground de-icing and in-flight de-icing. Such conductive layers in the wings may be pre-existing or may be added to the aircraft. Any aircraft with rotors, such as an electric vertical take-off and landing (eVTOL) aircraft, will require electrical thermal de-icing, as de-icing chemicals are not able to be sprayed onto the rotors.

During ground de-icing of an aircraft, the top of the aircraft wing surface will have some areas with zero degrees of angle (also known as the attack angle), relative to the ground. This means that if ice is detached from a surface with an attack angle of zero degrees, it will not be able to slide off via gravity alone.

Current towbar-less tows lift the front wheel of an aircraft off the ground for precise control of planes to push planes back from the gate or to use less fuel to move the plane on the ground. They do not use a towbar that connects from the tug to the front wheel assembly near the axle. Typically, the towbar-less tugs raise the front wheel assembly off of the ground just enough for the front wheels to clear the ground.

Embodiments of the present disclosure describe a towbar-less aircraft tow (also known as a tug) able to lift the plane to facilitate ground de-icing. While pulse electro-thermal de-icing (PETD) methods are utilized, the aircraft tow disclosed herein lifts the aircraft to change the angle at the top of a wing surface away from zero, which may be either up or down, to allow the ice that has detached via the interfacial melting to slide off the wing surface. As used herein, apparatus shall refer to a towbar-less aircraft tow.

According to an embodiment of the present disclosure, there is provided a towbar-less aircraft tow. The towbar-less aircraft tow includes a chassis configured to receive thereon at least a portion of an aircraft main landing gear assembly. The towbar-less aircraft tow further includes a lifting mechanism coupled to the chassis, configured to raise the aircraft main landing gear assembly by a variable amount. The towbar-less aircraft tow further includes a propulsion system coupled to the chassis, configured to move the towbar-less aircraft tow in a direction along a trajectory. The towbar-less aircraft tow further includes an electrical storage system coupled to the chassis. The towbar-less aircraft tow further includes a power connector mounted to said electrical storage system, configured to connect with an aircraft de-icing system for communicating electrical power from the towbar-less aircraft tow to the aircraft de-icing system during aircraft de-icing.

A fixed power connector ensures that the aircraft tow cannot disengage from the aircraft while the cable is connected to the aircraft. It also creates fixed points between the aircraft tow and the aircraft to reduce wear and prevent accidental contact of the power cable with ground personnel or other equipment.

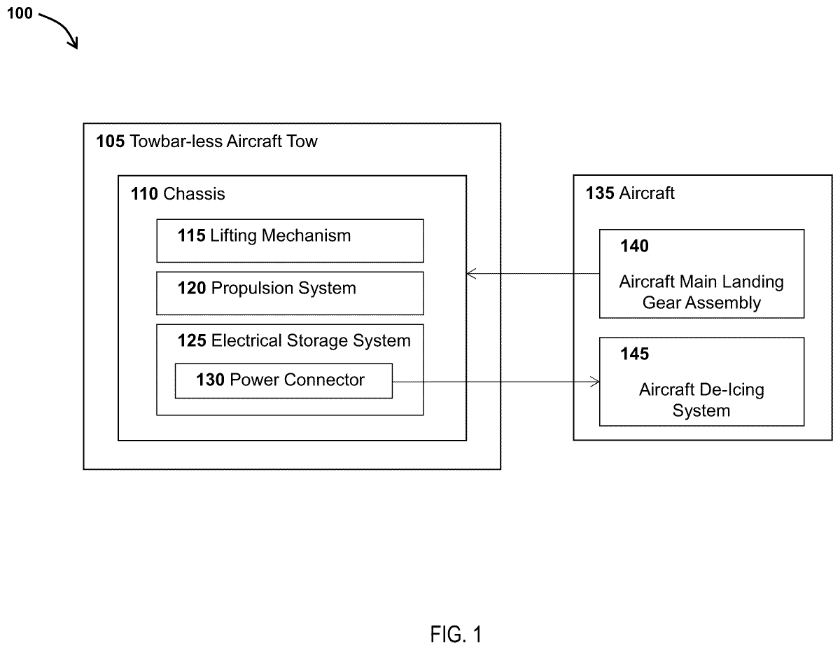

Referring to FIG. 1, depicted therein is an example system 100 for using a towbar-less aircraft tow, according to an embodiment of the present disclosure. In the system 100, a towbar-less aircraft tow 105 is depicted as being used in conjunction with an aircraft 135. The towbar-less aircraft tow 105 includes a chassis 110 configured to receive thereon at least a portion of an aircraft main landing gear assembly 140. The towbar-less aircraft tow 105 further includes a lifting mechanism 115 coupled to the chassis 110, configured to raise the aircraft main landing gear assembly 140 by a variable amount. The towbar-less aircraft tow 105 further includes a propulsion system 120 coupled to the chassis 110, configured to move the towbar-less aircraft tow 105 in a direction along a trajectory. The towbar-less aircraft tow 105 further includes an electrical storage system 125 coupled to the chassis 110. The towbar-less aircraft tow 105 further includes a power connector 130 mounted to said electrical storage system 125, configured to connect with an aircraft de-icing system 145 for communicating electrical power from the towbar-less aircraft tow 105 to the aircraft de-icing system 145 during aircraft de-icing.

In some embodiments, the towbar-less aircraft tow 105 may include several other components, such as, for example, functional components, safety related components, or remote-control components.

In various embodiments, further components of the towbar-less aircraft tow 105 may include a power unit, a seat, a steering wheel, a control panel and, in larger units, a cab for the operator.

In some embodiments, the electrical storage system 125 is a battery. In some embodiments, the electrical storage system 125 is a portable power supply.

In various embodiments, several different types of battery chemistry and voltages will be suitable and may be designed to work with an aircraft of a similar size (e.g., a small aircraft, a commuter aircraft, a single isle commercial, or a double aisle).

In some embodiments, power for the de-icing system 145 can be provided by the aircraft tow 105, a ground power unit (independent from the aircraft tow 105 and aircraft 135), the aircraft 135, a portable power supply/unit or other means.

In some embodiments, the portable power can be installed or added to the aircraft tow 105.

In some embodiments, the portable power can also be an independent, portable power unit having its own means to move around. Therefore, and in some embodiments, the portable power unit may not have a fixed connection to the aircraft, other than the power supply cable which is flexible.

In some embodiments, the power connector 130 is used to transfer de-icing status information between the towbar-less aircraft tow 105 and aircraft 135.

In various embodiments, the de-icing system 145 control of the heating, along with control of the aircraft tow 105 height and timing, can be provided located in the aircraft 135, the aircraft tow 105 or a ground power unit.

In some embodiment, the aircraft de-icing system 145 is internal to the aircraft, while in other embodiments the aircraft de-icing system 145 is external to the aircraft.

In some embodiments, the aircraft de-icing system 145 includes a controller configured to operate the towbar-less aircraft tow 105.

In various embodiments, the de-icing system 145 may be built into aircraft 135 during manufacturing. In such embodiments, the de-icing power and control may be supplied directly from aircraft 135, thereby obviating the need for ground power.

A controller within the de-icing system 145 may thus be configured to operate various aspects of the towbar-less aircraft tow 105 including, for example, actuating the lift and movement of the towbar-less aircraft tow 105. In this manner, the de-icing system 145 is able to achieve maximum efficiency by fully controlling the de-icing of the aircraft 135.

Benefits of the present disclosure include that the aircraft tow disclosed herein may be used not only for taxiing aircrafts, but also for de-icing. Typical aircraft tows raise the aircraft about 8 cm, just enough to clear it off the ground. The same lift mechanism may be used herein to raise the aircraft 30-60 cm (or more) in order to vary the surface angle of the wings. The safety feature described above of the fixed power connector prevents the aircraft tow from moving when it has lifted an aircraft. This is important as aircrafts are lifted much higher in embodiments of the present disclosure, as compared to in the prior art.

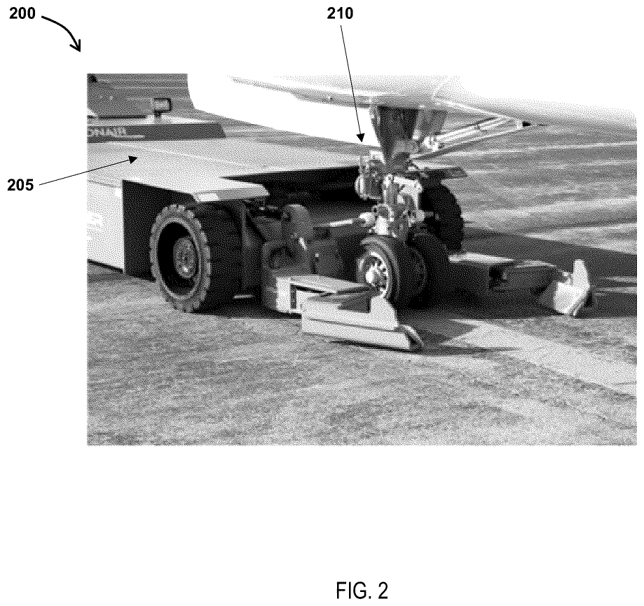

Referring now to FIG. 2, depicted therein is a side perspective of an example system 200, according to an embodiment of the present disclosure. The system 200 includes a towbar-less aircraft tow 205 and the main landing gear assembly 210 of an aircraft.

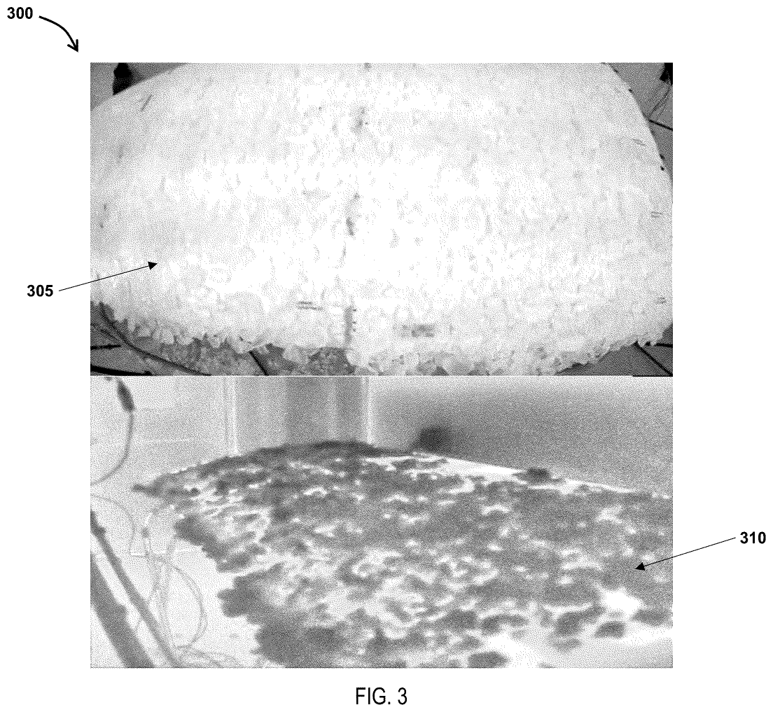

Referring now to FIG. 3, depicted therein are normal view 305 and heatmap view 310 of an aircraft wing approximately fifteen seconds into a de-icing process. As depicted, there is approximately three inches of ice present on the aircraft wing as the PETD system begins to heat specific layers of the aircraft wing.

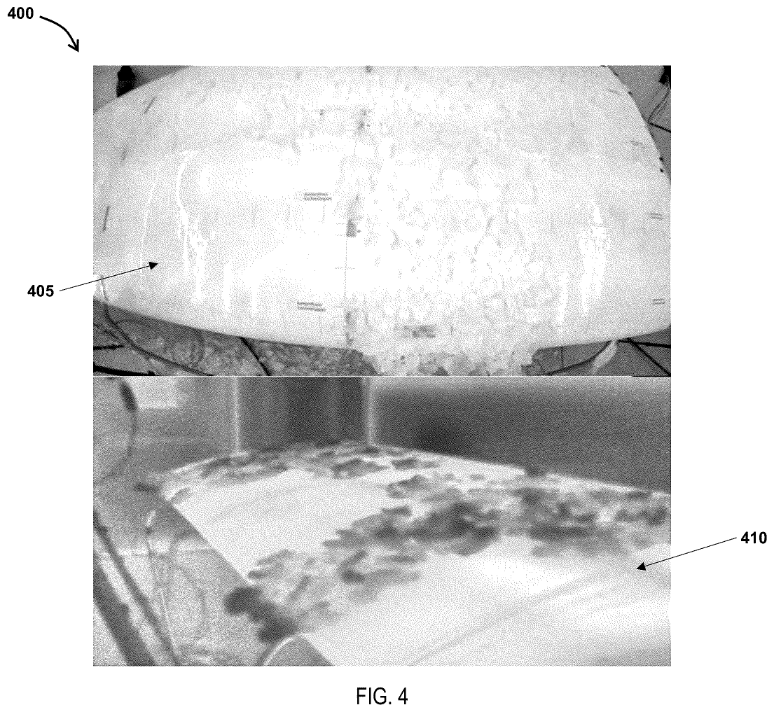

Referring now to FIG. 4, depicted therein are normal view 405 and heatmap view 410 of an aircraft wing approximately one minute into a de-icing process. As depicted, a significant proportion of the ice has melted and slid off the wing at this stage. By using the towbar-less aircraft tow to raise the aircraft to adjust the wing surface (attack) angle, much of the melted ice has quickly been removed.

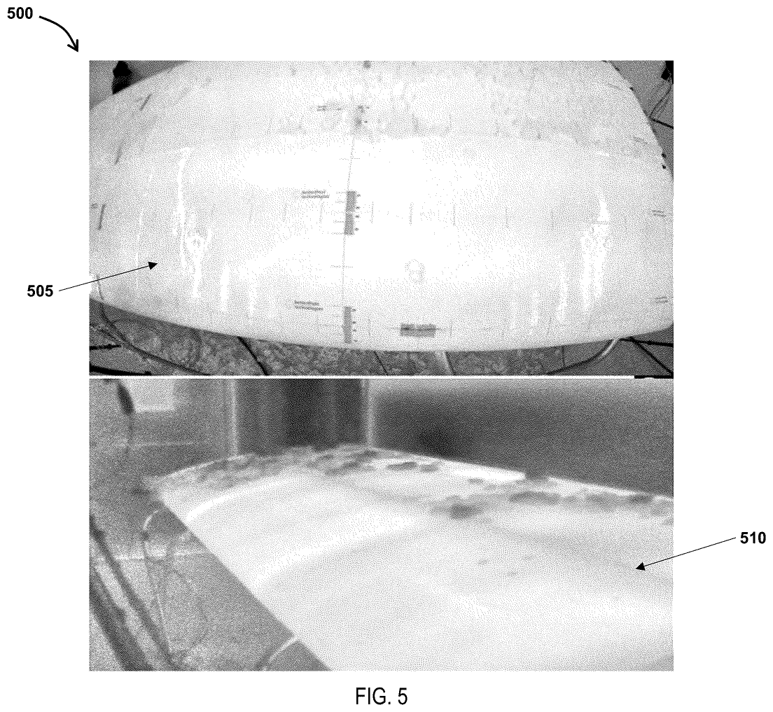

Referring now to FIG. 5, depicted therein are normal view 505 and heatmap view 510 of an aircraft wing approximately two minutes into a de-icing process. As depicted, at this stage, the aircraft wing is substantially free of any ice.

According to another embodiment of the present disclosure, there is provided a method of de-icing an aircraft.

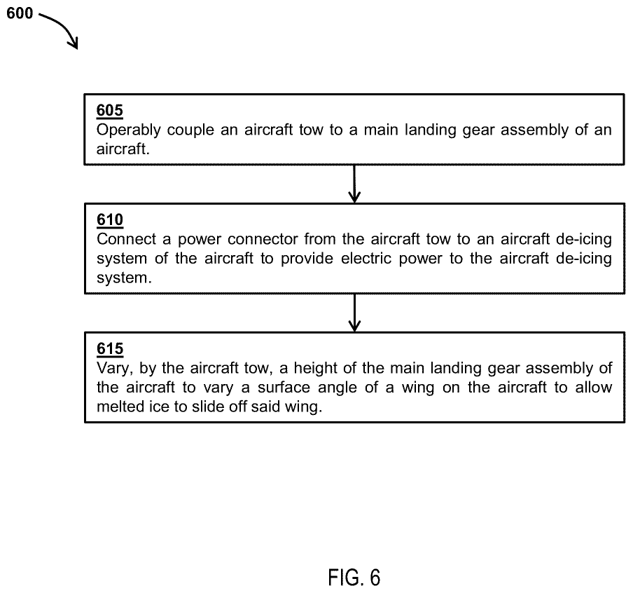

Referring now to FIG. 6, depicted therein is a method 600 of de-icing an aircraft. The method 600 includes at 605 operably coupling an aircraft tow to a main landing gear assembly of an aircraft. The method 600 further includes at 610 connecting a power connector from the aircraft tow to an aircraft de-icing system of the aircraft to provide electric power to the aircraft de-icing system. The method 600 further includes at 615 varying, by the aircraft tow, a height of the main landing gear assembly of the aircraft to vary a surface angle of a wing on the aircraft to allow melted ice to slide off said wing.

In some embodiments, the power connector is used to transfer de-icing status information between the aircraft tow and aircraft.

In some embodiments the main landing gear assembly of the aircraft may be varied by 30-60 cm (or even more depending on the aircraft) to change the aircraft wing angle of attack. This allows the ice to slide off once it detaches from the wing using pulse electro-thermal de-icing (PETD) techniques.

In some embodiments, a portable power supply is located at the aircraft tow.

In some embodiments, the method 600 further includes vibrating, by the aircraft tow, the landing gear assembly of an aircraft to remove ice from the wing. Ice may be further removed by shaking, for example, the front wheel of the aircraft.

In some embodiments, the method 600 further includes applying high-pressure air to remove ice from the wing. The high-pressure air may be, without limitation, from a ground source (e.g., the towbar-less aircraft tow) or a portable source.

As the angle of attack on an aircraft wing varies over the top of the surface and does not remain the same, in some embodiments timing the heating to match the maximum angle of attack is used to achieve effective and efficient operation. Methods and systems disclosed herein work in conjunction with the PETD algorithm to plan and adjust the timing of the de-icing so that the sections that heat up are done in conjunction with the height adjustment. The timing of the heating to a single section can be adjusted based on when that section reaches a maximum angle so the ice slides off.

In various embodiments, the height adjustment can be determined for each type of aircraft's wing geometry in order to change the angle of attack while the plane is on the ground and assist in the ice removal process.

In some embodiments, the method 600 may be carried out in an automated fashion, such that communications between an aircraft tow and an aircraft de-icing system are able to clean the wings of an aircraft of ice without the need for human intervention.

In some embodiments, the aircraft de-icing system includes a controller configured to operate the aircraft tow.

In various embodiments, the de-icing system may be built into the aircraft during manufacturing. In such embodiments, the de-icing power and control may be supplied directly from the aircraft, thereby obviating the need for ground power.

A controller within the de-icing system may thus be configured to operate various aspects of the aircraft tow including, for example, actuating the lift and movement of the aircraft tow. In this manner, the de-icing system is able to achieve maximum efficiency by fully controlling the de-icing of the aircraft.

While the above description provides examples of one or more apparatus, methods, or systems, it will be appreciated that other apparatus, methods, or systems may be within the scope of the claims as interpreted by one of skill in the art. Elements of each embodiment may be incorporated into other embodiments, for example, batteries discussed in relation to one embodiment, may be applied to other embodiments disclosed herein. Further, it is evident that various modifications and combinations can be made without departing from the invention. The specification and drawings are, accordingly, to be regarded simply as an illustration of the invention as defined by the claims, and are contemplated to cover any and all modifications, variations, combinations or equivalents that fall within the scope of the present invention.

1. A towbar-less aircraft tow comprising:
a chassis configured to receive thereon at least a portion of an aircraft main landing gear assembly;
a lifting mechanism coupled to the chassis, configured to raise the aircraft main landing gear assembly by a variable amount;
a propulsion system coupled to the chassis, configured to move the towbar-less aircraft tow in a direction along a trajectory;
an electrical storage system at the chassis; and
a power connector mounted to said electrical storage system, configured to connect with an aircraft de-icing system for communicating electrical power from the towbar-less aircraft tow to the aircraft de-icing system during aircraft de-icing.

2. The towbar-less aircraft tow of claim 1 further comprising at least one of: a power unit, a seat, a steering wheel, a control panel, and a cab for an operator.

3. The towbar-less aircraft tow of claim 1, wherein the electrical storage system is a battery.

4. The towbar-less aircraft tow of claim 1, wherein the electrical storage system is a portable power supply.

5. The towbar-less aircraft tow of claim 1, wherein the aircraft de-icing system includes an onboard controller configured for operating the towbar-less aircraft tow.

6. The towbar-less aircraft tow of claim 5, wherein operating the towbar-less aircraft tow includes operating the lifting mechanism to vary a height of the aircraft main landing gear assembly.

7. The towbar-less aircraft tow of claim 6, wherein varying the height of the aircraft main landing gear assembly changes a surface angle of a wing on the aircraft.

8. The towbar-less aircraft tow of claim 5, wherein operating the towbar-less aircraft tow includes vibrating the aircraft main landing gear assembly.

9. The towbar-less aircraft tow of claim 5, wherein operating the towbar-less aircraft tow includes providing high-pressure air.

10. The towbar-less aircraft tow of claim 1, wherein the aircraft de-icing system is configured to use pulse electro-thermal de-icing (PETD) techniques.

11. The towbar-less aircraft tow of claim 1, wherein the towbar-less aircraft tow and the aircraft de-icing system are in data communication.

12. A method of de-icing an aircraft, the method comprising:
operably coupling an aircraft tow to a main landing gear assembly of an aircraft;
connecting a power connector from the aircraft tow to an aircraft de-icing system of the aircraft to provide electric power to the aircraft de-icing system;
varying, by the aircraft tow, a height of the main landing gear assembly of the aircraft to vary a surface angle of a wing on the aircraft to allow melted ice to slide off said wing.

13. The method of claim 12, wherein a portable power supply is located at the aircraft tow.

14. The method of claim 12 further comprising vibrating, by the aircraft tow, the landing gear assembly of an aircraft to remove ice from said wing.

15. The method of claim 12 further comprising applying high-pressure air to remove ice from said wing.

16. The method of claim 12, wherein the aircraft de-icing system includes an onboard controller configured to operate the aircraft tow.

17. The method of claim 12, wherein the aircraft de-icing system is configured to use pulse electro-thermal de-icing (PETD) techniques.

18. The method of claim 12, wherein the aircraft de-icing system is one of: internal to the aircraft; and external to the aircraft.

19. The method of claim 12, wherein the aircraft tow and the aircraft de-icing system are in data communication.

20. The method of claim 19, wherein the data communication allows for automated de-icing of the aircraft without human intervention.
